(19) United States
(12) Patent Application Publication
(10) Pub. No.: US 2026/0295625 A1
(43) Pub. Date: Oct. 1, 2026

(54) EXTENSION WAND FOR A PISTOL GRIP HOSE NOZZLE AND METHOD THEREFOR

(71) Applicant: Ryan Pasichnyk, Simcoe (CA)

(72) Inventor: Ryan Pasichnyk, Simcoe (CA)

(21) Appl. No.: 19/096,941

(22) Filed: Apr. 1, 2025

(51) Int. Cl. B05B 15/656; B05B 9/01

(52) U.S. Cl. CPC B05B 15/656; B05B 9/01

(57) ABSTRACT

An extension wand for a pistol grip hose nozzle includes an adapter and a tube. The adapter has a first adapter portion and a second adapter portion. The first adapter portion matingly engages with a threaded head of a dispenser shaft of a pistol grip hose nozzle. The second adapter portion includes a lock device designed to receive and hold a pipe. The tube is L-shaped and includes a long tube portion and a short tube portion. The long tube portion has a first tube end and a second tube end. The first tube end is inserted into and held by the lock device such that the long tube portion extends parallel to the dispenser shaft of the pistol grip hose nozzle. The short tube portion is positioned at the second tube end and transverse to the long tube portion such that the short tube portion is oriented downwardly.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) Incorporation-by-reference of Material Submitted on a

### COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to hose wand extenders and more particularly pertains to a new extension wand for a pistol grip hose nozzle. Pistol grip hose nozzles are well known attachments for hoses to spray water. However, pistol grip hose nozzles are quite short, and in some instances it is advantageous to be able to spray the water in a focused manner from a distance. One such situation is the filling of containers in an animal enclosure, such as for horses, cows, and pigs. With a pistol grip hose nozzle, the user has to either spray into the enclosure or reach into the enclosure to hold the pistol grip hose nozzle over the container, such as a bucket, and spray directly into the container. Since the containers can be large, spraying from a distance through a fence or similar can be inaccurate and wasteful, whereas placing one's hand in the enclosure for an extended time risks harm to the user by the animal. The new extension wand allows users to insert the extension wand through the enclosure, thereby increasing accuracy of filling with the pistol grip hose nozzle with no risk to the user.

### (2) Description of Related Art Including Information Disclosed Under 37 CFR 1.97 and 1.98

The prior art relates to hose wand extenders. The prior art, as best understood, does not disclose an extension wand for a pistol grip hose nozzle that includes an adapter and a tube, wherein the adapter is designed to matingly engage with a threaded head of a dispenser shaft of a pistol grip hose nozzle, the tube is L-shaped and includes a long tube portion and a short tube portion, the first tube end is inserted into and held by a lock device of the adapter such that the long tube portion extends parallel to the dispenser shaft of the pistol grip hose nozzle, and the short tube portion is oriented downwardly when the adapter is connected to the pistol grip hose nozzle.

### (h) BRIEF SUMMARY OF THE INVENTION

An embodiment of the disclosure meets the needs presented above in an extension wand for a pistol grip hose nozzle generally comprising an adapter and a tube. The adapter has a first adapter portion and a second adapter portion. The first adapter portion is designed to matingly engage with a threaded head of a dispenser shaft of a pistol grip hose nozzle. The second adapter portion includes a lock device designed to receive and hold a pipe. The tube is L-shaped and includes a long tube portion and a short tube portion. The long tube portion has a first tube end and a second tube end. The first tube end is inserted into and held by the lock device such that the long tube portion extends parallel to the dispenser shaft of the pistol grip hose nozzle. The short tube portion is positioned at the second tube end and transverse to the long tube portion such that the short tube portion is oriented downwardly when the adapter is connected to the pistol grip hose nozzle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an extension wand according to an embodiment of the disclosure.

FIG. 2 is a bottom perspective view of an embodiment of the disclosure.

FIG. 3 is a close-up view of a component of an embodiment of the disclosure.

FIG. 4 is a perspective view of an embodiment of the disclosure in use.

FIG. 5 is a side view of an embodiment of the disclosure in use.

### (j) DETAILED DESCRIPTION OF THE INVENTION

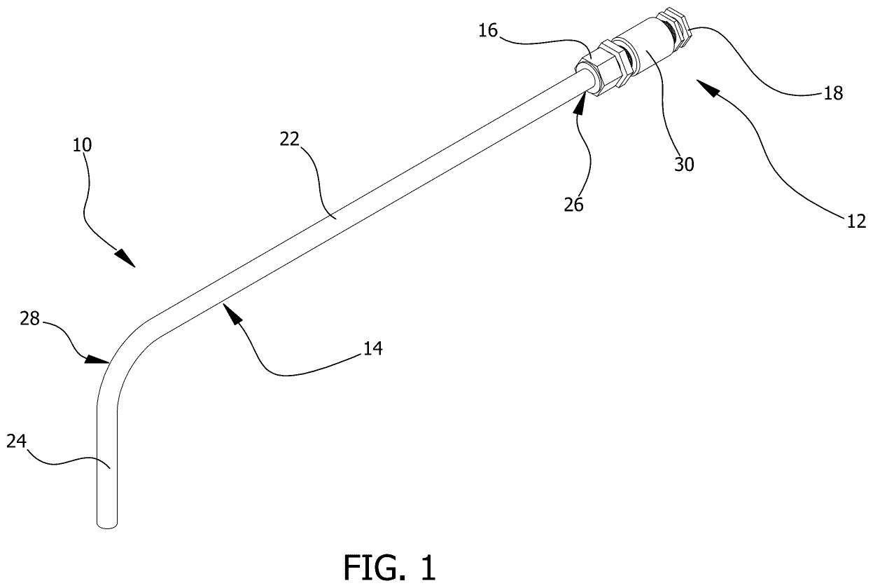

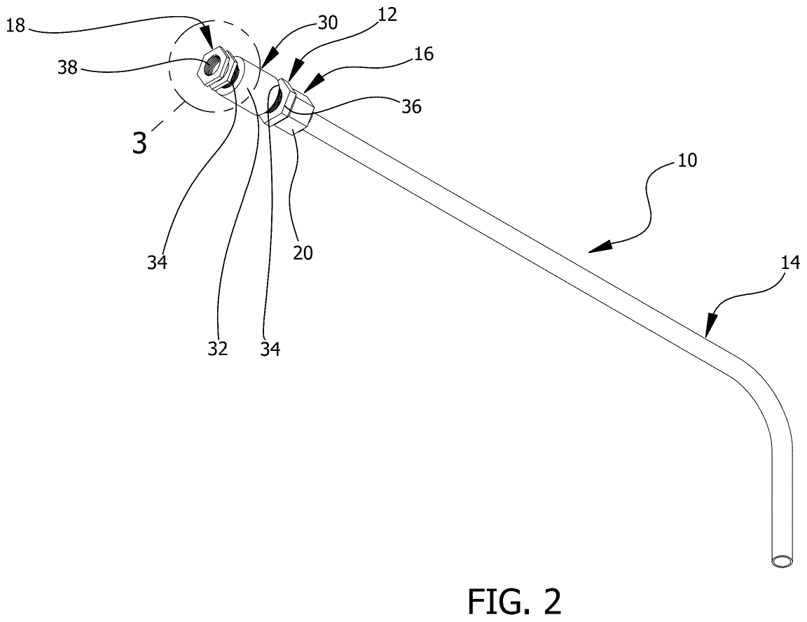

With reference now to the drawings, and in particular to FIGS. 1 through 5 thereof, a new extension wand embodying the principles and concepts of an embodiment of the disclosure and generally designated by the reference numeral 10 will be described.

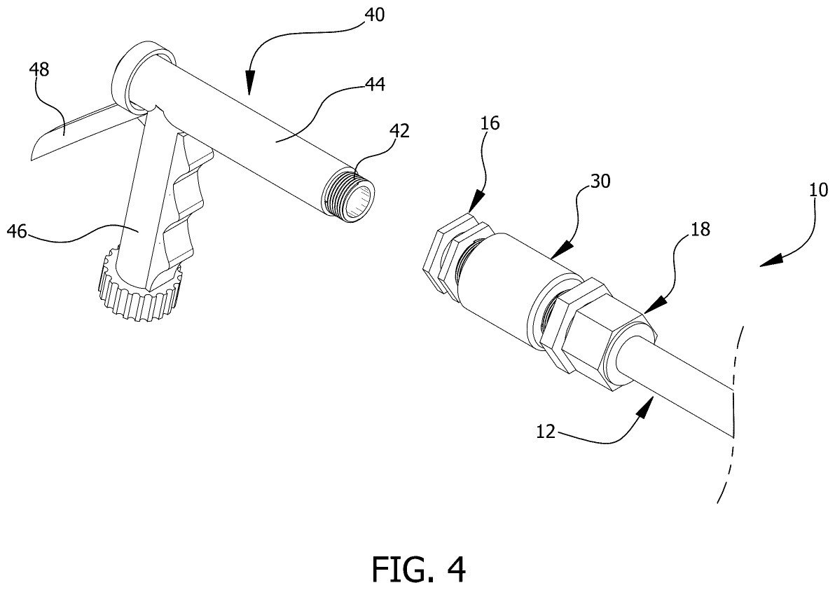

As best illustrated in FIGS. 1 through 5, the extension wand 10 for a pistol grip hose nozzle 40 generally comprises an adapter 12 and a tube 14. The adapter 12 has a first adapter portion 16 and a second adapter portion 18. As shown in FIG. 4, the first adapter portion 16 is designed to matingly engage with a threaded head 42 of a dispenser shaft 44 of the pistol grip hose nozzle 40. The second adapter portion 18 includes a lock device 20 designed to receive and hold a pipe. As shown in FIG. 1, the tube 14 is L-shaped and includes a long tube portion 22 and a short tube portion 24. The long tube portion 22 has a first tube end 26 and a second tube end 28. The first tube end 26 is inserted into and held by the lock device 20 such that the long tube portion 22 extends parallel to the dispenser shaft 44 of the pistol grip hose nozzle 40. The short tube portion 24 is positioned at the second tube end 28 and transverse to the long tube portion 22 such that the short tube portion 24 is oriented downwardly when the adapter 12 is connected to the pistol grip hose nozzle 40.

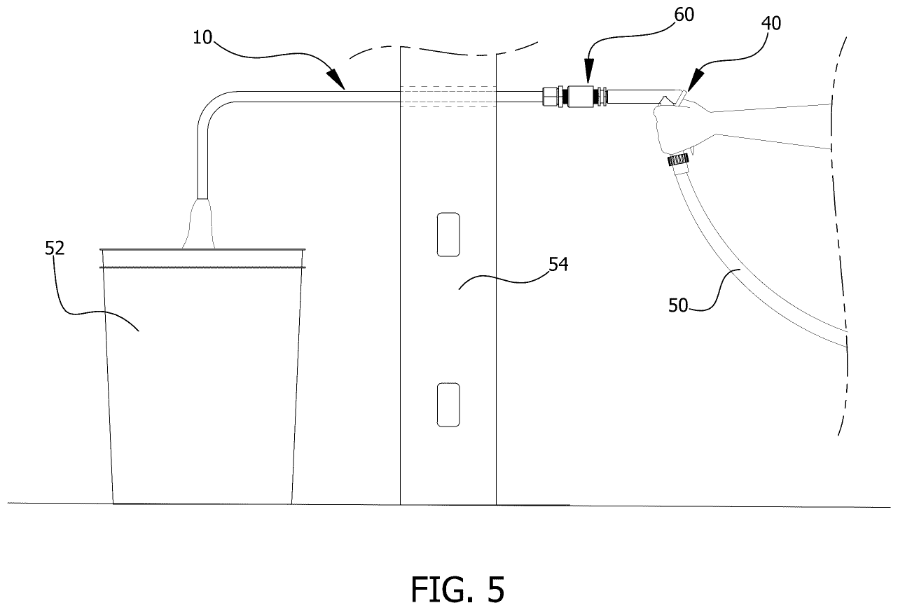

In the exemplary embodiment in FIG. 5, the long tube portion 22 is approximately three to four times as long as the short tube portion 24. However, the long tube portion 22 and the short tube portion 24 can be manufactured in any desired ratio.

In the exemplary embodiment in FIG. 5, the short tube portion 24 is positioned perpendicular to the long tube portion 22. However, in another possible embodiment, the short tube portion 24 could be oriented at an acute or obtuse angle with respect to the long tube portion 22 in the range of, for example 60 to 120 degrees.

In the exemplary embodiment, the tube 14 consists of metal, such as stainless steel, aluminum, copper, or brass, and has a diameter in the range of 0.250 to 0.750 inch. Other diameters common to tubes and pipes are within the scope of the disclosure. Other materials could also be used instead of metal, such as plastic.

The lock device 20 is a double ferrule compression fitting designed to grip and seal the first tube end 26 of the long tube portion 22. An example of a double ferrule compression fitting that could be used or adapted for use in the present invention is a Swagelok® fitting.

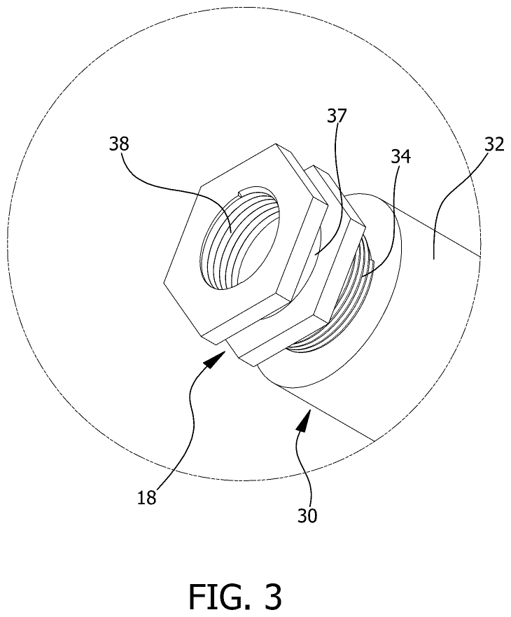

The adapter 12 includes a coupling 30 having a tubular body 32 and two threaded connectors 34 at either end of the tubular body 32. The first adapter portion 16 includes a threaded end 36 coupled to a respective one of the threaded connectors 34 of the coupling 30. The second adapter portion 18 includes a first threaded end 37 coupled to a respective one of the threaded connectors 34 of the coupling 30 and a second threaded end 38 designed to couple with the threaded head 42 of the dispenser shaft 44 of the pistol grip hose nozzle 40. For example, the coupling 30 could be a 0.75 inch stainless steel coupling 30 that connects the first adapter portion 16 and the second adapter portion 18, such as if a reduction is needed between connections of different diameters, such as a 0.5 inch to 0.75 inch connection. An exemplary embodiment of the second adapter portion 18 is shown in detail in FIG. 3, wherein the second adapter portion 18 is a brass fitting that has a 0.75 inch female ×0.75 inch tapered thread, such as an NPT (National Pipe Thread) thread, and hex nut portions for adjustment and turning. However, this is only one exemplary embodiment, and other connections and sizes could be used as are well known in the piping arts.

In one possible embodiment, the extension wand 10 is part of a hose nozzle assembly 60 that includes the pistol grip hose nozzle 40. The hose nozzle assembly is shown in FIG. 5, wherein the pistol grip hose nozzle 40 includes a handle 46, the dispenser shaft 44, the threaded head 42, and a trigger 48. The handle 46 is connectable to a hose 50. The dispenser shaft 44 extends from and is transverse to the handle 46. The threaded head 42 is disposed at an end of the dispenser shaft 44. The trigger 48 is connected to the dispenser shaft 44. The trigger 48 is designed to open and close the dispenser shaft 44 to selectively turn the flow of water on and off. In one possible embodiment, the extension wand 10 is integrally formed with and cannot be disconnected from the pistol grip hose nozzle 40.

The extension wand 10 is used to allow a user to fill a container 52 from a distance. The extension wand 10 can be screwed on and off the pistol grip hose nozzle 40 to switch between the concentrated filling provided by the extension wand 10 and normal spraying by the pistol grip hose nozzle 40. One use is safely filling a container 52 in an animal enclosure 54 with water. The user screws the first adapter portion 16 of the adapter 12 to the threaded head 42 of the dispenser shaft 44 of the pistol grip hose nozzle 40 until the short tube portion 24 is oriented downwardly as shown in FIG. 5. The user then inserts the tube 14 into the animal enclosure 54 with the short tube portion 24 above a container 52, such as a bucket or trough, in the animal enclosure 54. The user then activates the pistol grip hose nozzle 40 by squeezing the trigger 48 and dispenses water downwardly into the container 52. Filling of the container 52 can thereby be done accurately and safely as the user does not need to insert his or her hand into the animal enclosure 54. It should be noted that the use with the animal enclosure 54 is only one possible use, and the extension wand 10 can be used to fill other container 52s at a distance.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An extension wand for a pistol grip hose nozzle comprising:
an adapter, the adapter having a first adapter portion and a second adapter portion, the first adapter portion being configured to matingly engage with a threaded head of a dispenser shaft of a pistol grip hose nozzle, the second adapter portion including a lock device being configured to receive and hold a pipe; and
a tube, the tube being L-shaped and including a long tube portion and a short tube portion, the long tube portion having a first tube end and a second tube end, the first tube end being inserted into and held by the lock device such that the long tube portion extends parallel to the dispenser shaft of the pistol grip hose nozzle, the short tube portion being positioned at the second tube end and transverse to the long tube portion such that the short tube portion is oriented downwardly when the adapter is connected to the pistol grip hose nozzle.

2. The extension wand of claim 1, wherein the long tube portion is approximately three to four times as long as the short tube portion.

3. The extension wand of claim 1, wherein the short tube portion is positioned perpendicular to the long tube portion.

4. The extension wand of claim 1, wherein the tube consists of metal and has a diameter in the range of 0.250 to 0.750 inch.

5. The extension wand of claim 1, wherein the lock device is a double ferrule compression fitting configured to grip and seal the first tube end of the long tube portion.

6. The extension wand of claim 1, wherein:
the adapter includes a coupling having a tubular body and two threaded connectors at either end of the tubular body;
the first adapter portion includes a threaded end coupled to a respective one of the threaded connectors of the coupling; and
the second adapter portion includes a first threaded end coupled to a respective one of the threaded connectors of the coupling and a second threaded end configured to couple with the threaded head of the dispenser shaft of the pistol grip hose nozzle.

7. The extension wand of claim 2, wherein the short tube portion is positioned perpendicular to the long tube portion.

8. The extension wand of claim 7, wherein the tube consists of metal and has a diameter in the range of 0.250 to 0.750 inch.

9. The extension wand of claim 8, wherein the lock device is a double ferrule compression fitting configured to grip and seal the first tube end of the long tube portion.

10. The extension wand of claim 9, wherein:
the adapter includes a coupling having a tubular body and two threaded connectors at either end of the tubular body;
the first adapter portion includes a threaded end coupled to a respective one of the threaded connectors of the coupling; and
the second adapter portion includes a first threaded end coupled to a respective one of the threaded connectors of the coupling and a second threaded end configured to couple with the threaded head of the dispenser shaft of the pistol grip hose nozzle.

11. A hose nozzle assembly comprising:
a pistol grip hose nozzle, the pistol grip hose nozzle including:
a handle, the handle being connectable to a hose;
a dispenser shaft, the dispenser shaft extending from and transverse to the handle;
a threaded head, the threaded head being disposed at an end of the dispenser shaft; and
a trigger, the trigger being connected to the dispenser shaft, the trigger being configured to open and close the dispenser shaft to selectively turn the flow of water on and off; and
an extension wand, the extension wand including:
an adapter, the adapter having a first adapter portion and a second adapter portion, the first adapter portion being configured to matingly engage with a threaded head of a dispenser shaft of a pistol grip hose nozzle, the second adapter portion including a lock device being configured to receive and hold a pipe; and
a tube, the tube being L-shaped and including a long tube portion and a short tube portion, the long tube portion having a first tube end and a second tube end, the first tube end being inserted into and held by the lock device such that the long tube portion extends parallel to the dispenser shaft of the pistol grip hose nozzle, the short tube portion being positioned at the second tube end and transverse to the long tube portion such that the short tube portion is oriented downwardly when the adapter is connected to the pistol grip hose nozzle.

12. The hose nozzle assembly of claim 11, wherein the long tube portion is approximately three to four times as long as the short tube portion.

13. The hose nozzle assembly of claim 12, wherein the short tube portion is positioned perpendicular to the long tube portion.

14. The hose nozzle assembly of claim 13, wherein the tube consists of metal and has a diameter in the range of 0.250 to 0.750 inch.

15. The hose nozzle assembly of claim 14, wherein the lock device is a double ferrule compression fitting configured to grip and seal the first tube end of the long tube portion.

16. The hose nozzle assembly of claim 15, wherein:
the adapter includes a coupling having a tubular body and two threaded connectors at either end of the tubular body;
the first adapter portion includes a threaded end coupled to a respective one of the threaded connectors of the coupling; and
the second adapter portion includes a first threaded end coupled to a respective one of the threaded connectors of the coupling and a second threaded end configured to couple with the threaded head of the dispenser shaft of the pistol grip hose nozzle.

17. A method of safely filling a container in an animal enclosure with water, the method comprising the steps of:
providing an extension wand for a pistol grip hose nozzle comprising:
an adapter, the adapter having a first adapter portion and a second adapter portion, the first adapter portion being configured to matingly engage with a threaded head of a dispenser shaft of a pistol grip hose nozzle, the second adapter portion including a lock device being configured to receive and hold a pipe; and
a tube, the tube being L-shaped and including a long tube portion and a short tube portion, the long tube portion having a first tube end and a second tube end, the first tube end being inserted into and held by the lock device such that the long tube portion extends parallel to the dispenser shaft of the pistol grip hose nozzle, the short tube portion being positioned at the second tube end and transverse to the long tube portion such that the short tube portion is oriented downwardly when the adapter is connected to the pistol grip hose nozzle;
screwing the first adapter portion of the adapter to a threaded head of a dispenser shaft of a pistol grip hose nozzle until the short tube portion is oriented downwardly;
inserting the tube into an animal enclosure with the short tube portion above a container in the animal enclosure; and
activating the pistol grip hose nozzle and dispensing water downwardly into the container.
